(19) United States
(12) Patent Application Publication
(10) Pub. No.: US 2007/0212999 A1
(43) Pub. Date: Sep. 13, 2007

(54) Duct attachment for motor vehicle

(76) Inventors: Ted M. Godett, Waterford, MI (US); Brian J. Zawadzki, Washington, MI (US)

Correspondence Address: GENERAL MOTORS CORPORATION;LEGAL STAFF, MAIL CODE 482-C23-B21, P O BOX 300, DETROIT, MI, 48265-3000, US

(21) Appl. No.: 11/369,807

(22) Filed: Mar. 7, 2006

(51) Int. Cl. B60J 1/20

(52) U.S. Cl. 454/128

(57) ABSTRACT

A pillar assembly for a vehicle includes vertically extending and horizontally extending walls defining a hollow space extending axially within the pillar. An HVAC duct of molded plastic is disposed within the hollow space and a plurality of attachment clips loosely attach the duct in place with an air inlet and air outlet of the duct aligned respectively with first and second openings in the pillar walls. A plurality of beads of heat-expandable adhesive are placed at intervals along the duct and expand upon heating of the vehicle in a paint curing oven so that the adhesive expands and becomes adhered to both the duct and pillar walls. The adhesive remains compliant in this expanded condition so that the duct is adequately retained in place and yet isolated from undue loading of the duct when the pillar experiences flexure.

### FIELD OF THE INVENTION

The present invention relates to the attachment of an HVAC duct within the hollow space of a vehicle pillar.

### BACKGROUND OF THE INVENTION

It is known to encase an HVAC duct within a layer of structural foam, and to then use a heat-expandable epoxy to rigidly mount the foam encased duct within a pillar of a motor vehicle body. The duct and its structural foam layer thus become part of the load-carrying structure of the vehicle pillar.

It would be desirable to provide a new and improved mounting arrangement for an HVAC duct within a pillar so that the plastic duct would not be subjected to flexure loads when the pillar is subjected to flexure during operation of the vehicle.

### SUMMARY OF THE INVENTION

The pillar assembly for an automotive vehicle includes a vertically extending section and a horizontally extending section including walls defining a hollow space extending axially within the pillar. The hollow space communicates with a first opening through the vertical extending section and a second opening through the horizontal extending section. An HVAC duct of molded plastic is disposed within the hollow space and extends between the first and second openings. The duct has an air inlet aligned with the first opening and an air outlet aligned with the second opening so that the duct circulates airflow from the air inlet to the air outlet. A plurality of attachment clips loosely attach the duct in place with the air inlet and air outlet aligned respectively with the first and second openings. A plurality of beads of heat-expandable adhesive is placed at intervals along the duct and expand upon heating of the vehicle in a paint curing oven so that the adhesive expands and becomes adhered to both the duct and pillar. The adhesive remains compliant in this expanded condition so that the duct is adequately retained in place and yet isolated by the compliance of the adhesive from undue loading of the duct when the pillar experiences flexure. Thus, the duct will properly remain in place to communicate air from the air inlet to the air outlet and will not fracture or be damaged upon flexure of the vehicle body.

Further areas of applicability of the present invention will become apparent from the detailed description provided hereinafter. It should be understood that the detailed description and specific examples, while indicating exemplary embodiments of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is an exploded perspective view of a vehicle body having a pillar structure within which an HVAC duct is mounted during assembly of the body;

FIG. 2 is a perspective view of the duct;

FIG. 3 is a perspective view showing the other side of the duct;

FIG. 4 is a section view taken through the pillar and showing the duct loosely held in place by push in type fasteners; and

FIG. 5 is a section view similar to FIG. 4 and taken through the pillar but showing the pillar after passage through a paint curing oven has caused the expandable adhesive to compliantly attach the duct within the hollow space of the pillar.

### DETAILED DESCRIPTION OF THE EXEMPLARY EMBODIMENTS

The following description of the certain exemplary embodiments are merely exemplary in nature and are not intended to limit the invention, its application, or uses.

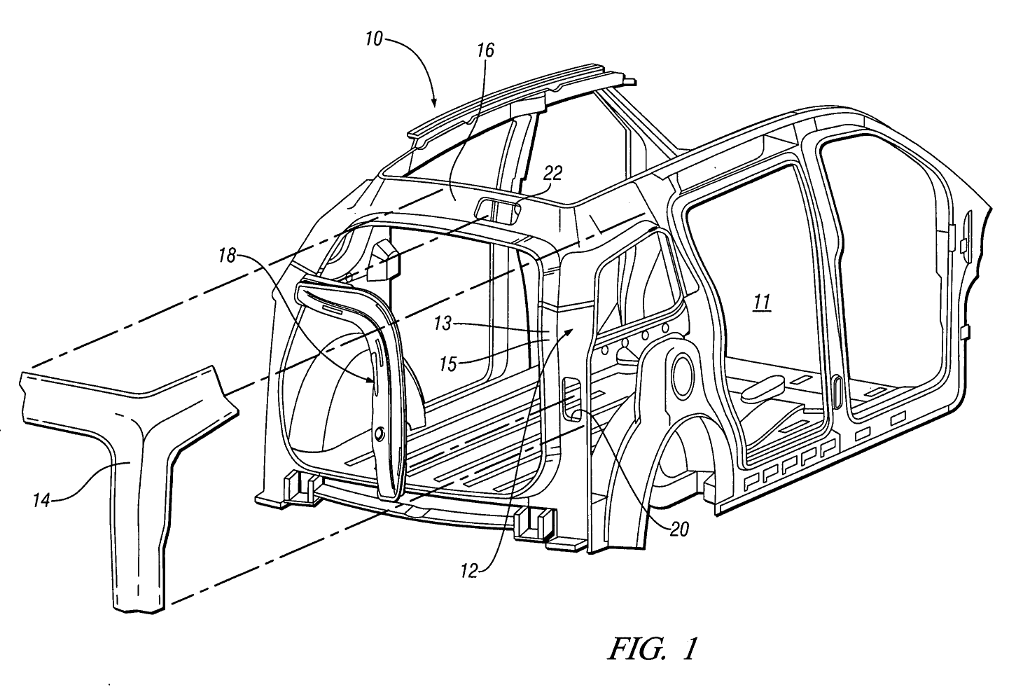

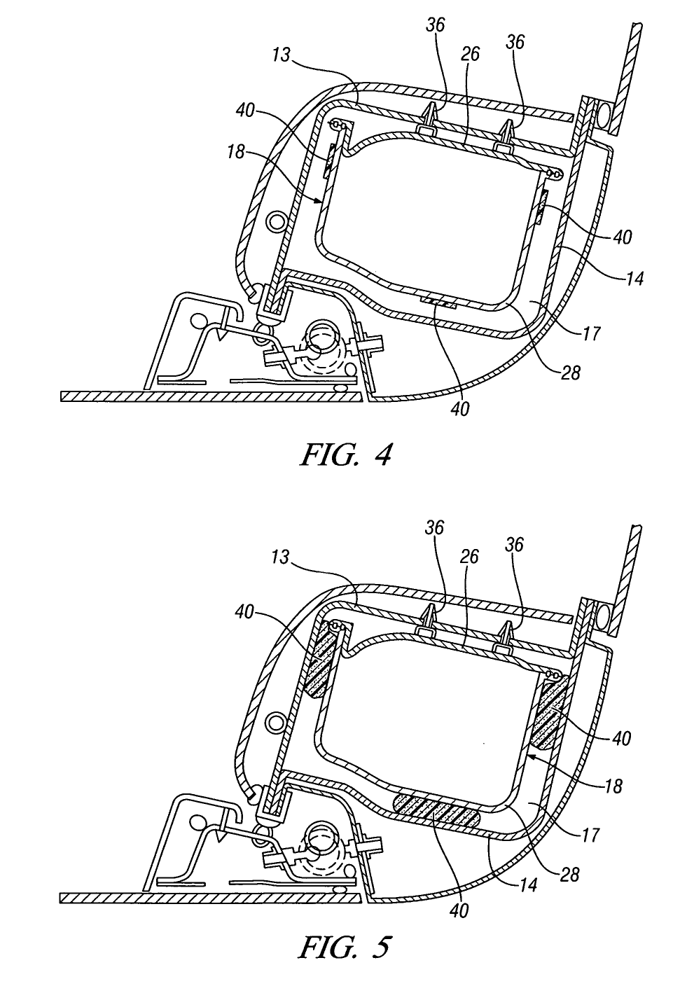

Referring now to FIG. 1, there is shown a vehicle body 10 for a vehicle such as a van, sports utility vehicle, or a station wagon. The vehicle body 10 surrounds a passenger compartment 11 and is constructed and arranged to support exterior body panels, not shown. As seen in FIG. 1, vehicle body 10 is comprised of a number of sheet metal stampings that are welded together. Vehicle body 10 includes a rear pillar structure 12 that has an inner wall panel 13 and an outer wall panel 14. FIG. 1 shows the outer wall 14 in a position displaced from the inner wall panel 13. The rear pillar structure 12 has a right pillar portion 15 and a rear roof header 16. The outer wall panel 14 will be welded in place atop the inner wall panel 13 to provide an axially extending space 17, as seen in FIG. 4, between the inner wall panel 13 and the outer wall panel 14. As seen in FIG. 1, an HVAC duct 18 is provided for mounting within the axial extending space 17 defined between the inner wall panel 13 and the outer wall panel 14.

As seen in FIG. 1, the inner wall panel 13 of the rear pillar includes an air inlet opening 20 and an air outlet opening 22. The air inlet opening 20 is provided in the vertical extending portion of the inner wall panel 13 and the outlet opening 22 is provided in the horizontal extending portion of the inner wall panel 13.

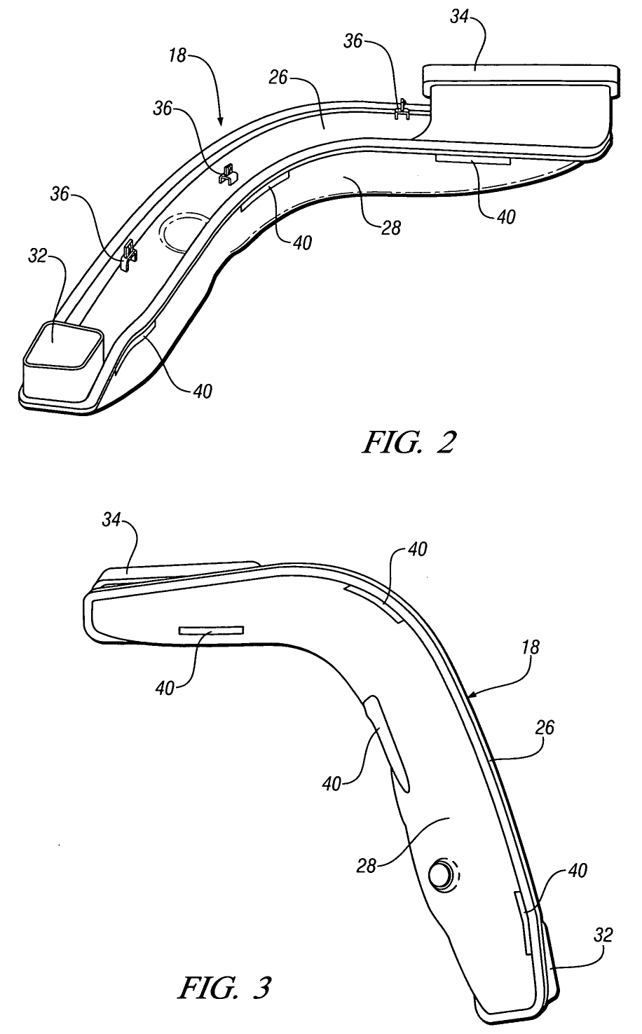

Referring to FIGS. 2 and 3, the HVAC duct 18 is shown. The duct 18 is formed by gluing or heat staking together a first molded portion 26 and second molded portion 28 to define a hollow duct having an air inlet 32 at lower end and an air outlet 34 at the upper end. A plurality of push-in type fasteners 36 are provided on the duct 18. These push-in type fasteners 36 may be of either metal or plastic construction and are well known in the automotive industry. In addition, several beads of heat-expandable adhesive 40 are dispensed at intervals along the length of the duct as seen in FIGS. 2 and 3. This adhesive may be either a liquid that is dispensed onto the duct 18 or a preformed adhesive bead such as a tape that is installed on the duct 18.

Referring again to FIG. 1, it is understood that the duct 18 is installed onto the inner wall panel 13 of the vehicle body rear pillar structure 12. Small apertures, not shown, are provided in the inner wall panel 13 of the rear pillar structure 12 to receive the push-in type fasteners 36, as best seen in FIG. 4. The push-in type fasteners 36 will hold the duct 18 in place loosely and temporarily with the air inlet 32 at the bottom of the duct 18 aligned with the inlet opening 20 of the inner wall panel 13, and the air outlet 34 at the upper end of the duct 18 aligned with the air outlet opening 22.

After the duct 18 is loosely attached to the inner wall panel 13 by the push-in type fasteners 36, the outer wall panel 14 will be placed over top the duct 18 and suitably welded to the inner wall panel 13 so that the outer wall panel 14 becomes an integral part of the rear pillar structure 12 of the vehicle body 10. Thus, as best seen in FIG. 4, the inner wall panel 13 and the outer wall panel 14 cooperate to define therebetween an axially-extending space 17 in which the duct 18 is housed and loosely held in place by the push-in type fasteners 36. As seen in FIG. 4, the beads of adhesive 40 carried by the duct 18 are situated in proximity to the inner wall panel 13 and the outer wall panel 14 but are not in contact therewith.

Referring now to FIG. 5, it is seen that the beads of expandable adhesive have been expanded. This expansion of the adhesive occurs when the vehicle body 10 passes through the paint curing ovens typically employed in vehicle body manufacturing plants. Typically, the vehicle body 10 will be exposed to temperatures of about 320° F. for a period of 20 to 30 minutes in order to dry the prime coat, and then heated again for drying the color coat. Each bead of expandable adhesive 30 expands and adheres to both the duct 18 and the adjacent one of either the inner wall panel 13 or outer wall panel 14.

It will be understood and appreciated that the particular adhesive is selected from among the commercially available range of expandable adhesives, to provide the desirable characteristics of having sufficient strength to reliably secure the duct 18 in place without rattle or vibration, and yet the adhesive will remain compliant and flexible so that upon flexure of the vehicle pillar structure 12 during operation of the vehicle, the duct 18 will be substantially isolated from any significant force imposed thereon by flexure of the adhesive, thereby avoiding fracture or other damage of the plastic material from which the duct 18 is molded. One suitable adhesive is sold by L & L Products Inc., 160 McLean, Romeo, Mich., 48065 as L7220 Expandable Foam.

It will be understood and appreciated that the adhesive is applied only at selected locations on the periphery of the duct 18 in order to reach the desired compromise of having enough adhesive to adequately secure the duct 18 in place and yet not so much adhesive that the duct 18 would be severely bound to the inner wall panels 13 and outer wall panel 14 in a way that would cause the duct 18 to be subjected to excessive force during flexure of the vehicle body 10.

The description of the invention is merely exemplary in nature and, thus, variations thereof are intended to be within the scope of the invention. For example, although the duct is shown herein as for the purpose of communicating air between an inlet and outlet, the duct could also be useful for running wire or cable or fluid lines through regions of the vehicle body. And, although the drawings show the bead of heat-expandable adhesive as placed at intervals along the length of the duct, the beads of adhesive could alternatively be placed at intervals along the surface of either or both of the inner wall panel and outer wall panel that define the axial space 17 in which the duct is to be compliantly mounted.

What is claimed is:

1. An HVAC duct and pillar assembly for an automotive vehicle comprising:
a pillar having a vertically extending section and a horizontally extending section including walls defining a hollow space extending axially therein, the hollow space communicating with a first opening through the vertical extending section and a second opening through the horizontal extending section;
an HVAC duct disposed within the hollow space and extending between the first and second openings, the duct having an air inlet aligned with the first opening and an air outlet aligned with the second opening;
a plurality of attachment clips attaching the duct in place with the air inlet and outlet aligned respectively with the first and second opening;
and heat-expandable adhesive disposed between the duct and the walls defining the hollow space in the pillar, the heat-expandable adhesive being heated in a paint curing oven so that the adhesive is adhered to both the duct and the walls of the pillar, the adhesive remaining compliant in the expanded condition so that the duct is adequately retained in place and yet isolated by the compliance of the adhesive from undue loading of the duct when the vehicle pillar experiences flexure.

2. The duct and pillar assembly of claim 1 further comprising the pillar walls including a first wall panel to which the duct is loosely attached in place by the plurality of attachment clips to align the air inlet and outlet of the duct with first and second openings provided in the first wall panel, and a second wall panel that is welded in place onto the first wall panel, thereby forming the hollow space in which the duct awaits passage of the vehicle into the paint oven to expand the compliant adhesive and thereby adhere the duct to both the first and second wall panels.

3. The duct and pillar assembly of claim 1 in which the heat-expandable adhesive is applied in beads of expandable adhesive that are sized and located at distances apart from one another to perform the function of retaining the duct and yet the retention is sufficiently compliant that the pillar may flex under loading without injury to the duct.

4. The duct and pillar assembly of claim 3 in which the beads of heat-expandable adhesive are applied at intervals along the duct and expands into contact with the walls of the pillar.

5. The duct and pillar assembly of claim 3 in which the beads of heat-expandable adhesive are applied at intervals along the walls of the pillar and expand into contact with the duct.

6. The duct and pillar assembly of claim 1 in which the pillar is made of sheet metal that withstands flexure of the vehicle and the duct is made of plastic and less able to withstand flexure of the vehicle.

7. An HVAC duct and pillar assembly for an automotive vehicle comprising:
a pillar including an inner sheet metal panel and an outer sheet metal panel that is attached to the inner panel to cooperatively define a hollow space extending axially therein, the hollow space communicating with a first opening of the inner panel and a second opening of the inner panel;
a plastic HVAC duct disposed within the hollow space and extending between the first and second openings, the duct having an air inlet aligned with the first opening and an air outlet aligned with the second opening;
a plurality of attachment clips loosely attaching the duct in place on the inner panel with the air inlet and outlet aligned respectively with the first and second opening;
and a first plurality of beads of expandable adhesive placed at intervals along the duct and facing toward the first panel and a second plurality of beads of adhesive placed at intervals along the duct and facing toward the second panel, the expandable adhesive being expanded upon heating of the vehicle in a paint curing oven so that the adhesive is adhered to both the duct and the first and second panels of the pillar, the adhesive remaining compliant in the expanded condition so that the duct is adequately retained in place and yet isolated by the compliance of the adhesive from undue loading of the duct when the first and second panels of the vehicle pillar experience flexure.

8. The duct and pillar assembly of claim 7 in which the adhesive is a liquid that is dispensed at intervals along the duct.

9. The duct and pillar assembly of claim 7 in which the adhesive is a tape that is placed at intervals along the duct.

10. An HVAC duct and pillar assembly for an automotive vehicle comprising:
a pillar including an inner sheet metal panel and an outer sheet metal panel that is attached to the inner panel, each of the inner and outer panel having a vertically extending section and a horizontally extending section, and the inner and outer panels cooperating to define a hollow space extending axially therein, the hollow space communicating with a first opening through the vertical section of the inner panel and a second opening through the horizontal section of the inner panel;
a plastic HVAC duct having an air inlet and an air outlet, said plastic HVAC duct carrying a plurality of beads of heat-expandable compliant adhesive placed at intervals along the duct;
and a plurality of attachment clips carried by the duct and loosely attaching the duct in place on at least one of the inner panel and outer panel with the air inlet and air outlet of the duct aligned respectively with the first and second openings of the pillar and the plurality of beads of the heat-expandable adhesive facing toward at least the one of the inner panel and outer panel so that upon passage of the vehicle through a paint curing oven the heat-expandable adhesive is expanded and adheres the duct to the one of the inner and outer panels in a compliant fashion so the that duct is adequately retained in place and yet isolated by the compliance of the adhesive from undue loading of the duct when the first and second panels of the vehicle pillar experience flexure.

11. The duct and pillar assembly of claim 10 further comprising the plurality of beads of heat-expandable adhesive facing toward and adhering to both the inner panel and the outer panels.

12. The duct and pillar assembly of claim 10 in which the adhesive is a liquid that is dispensed at intervals along the duct.

13. The duct and pillar assembly of claim 10 in which the adhesive is a tape that is placed at intervals along the duct.
